(19) United States
(12) Patent Application Publication
(10) Pub. No.: US 2016/0353157 A1
(43) Pub. Date: Dec. 1, 2016

(54) PROVIDING INFORMATION ABOUT AN OBJECT IN A DIGITAL VIDEO SEQUENCE

(71) Applicant: ALCATEL LUCENT, Boulogne-Billancourt (FR)

(72) Inventors: Karthick RAJAPANDIYAN, Chennai (IN); Harikumar PANDURANGAN, Thiruvallur (IN)

(73) Assignee: Alcatel Lucent, Boulogne-Billancourt (FR)

(21) Appl. No.: 15/110,105

(22) PCT Filed: Nov. 18, 2014
(86) PCT No.: PCT/EP2014/074851

§ 371 Date: Jul. 7, 2016

(30) Foreign Application Priority Data
Jan. 7, 2014 (IN) 55/DEL/2014

(51) Int. Cl. H04N 21/433; H04N 21/845; H04N 21/81; H04N 21/4728

(52) U.S. Cl. CPC H04N 21/4333; H04N 21/4728; H04N 21/8455; H04N 21/812; H04N 21/8133; H04N 21/8358

(57) ABSTRACT

The method includes receiving a first input from a user to pause the digital video sequence running on a display device. A video frame is displayed to the user when the digital video sequence is paused. The video frame is shared with an image processing server to receive a processed image of the video frame. The processed image includes a plurality of objects identified in the video frame and allows navigating between the plurality of objects. A second input is received from the user upon selection of an object of interest from the plurality of objects. Based on the selection, a search request is sent to a search server. Search results received from the search server are provided to the user.

### FIELD OF INVENTION

The present subject matter relates to digital videos sequences and, particularly, but not exclusively, to providing information about an object in a digital video sequence.

### BACKGROUND

Digital television (DTV) is an advanced broadcasting technology that has transformed the television viewing experience. DTV technology enables broadcasters to offer television content with better picture and sound quality, and multiple channels of programming. DTV technology includes transmission of audio and video by digitally processed and multiplexed signal, in contrast to the totally analog and channel separated signals used by analog television. The DTV broadcast systems may be implemented as direct-to-home (DTH) television, video on demand (VoD), and Internet protocol television (IPTV). DTH may be understood as reception of satellite content with the help of a personal dish and a set-top-box (STB). IPTV services facilitate providing digital broadcasting service of regular television channels over the Internet. DTVs are becoming increasingly popular as they can provide greater control over television content to the users, allowing the users to perform various functions, such as forwarding the content, pausing the content, recording the content, and rewinding the content.

### SUMMARY

This summary is provided to introduce concepts related to providing information about an object in a digital video sequence. This summary is not intended to identify essential features of the claimed subject matter nor is it directed to use in determining or limiting the scope of the claimed subject matter.

In an embodiment, a method for providing information about an object in a digital video sequence is disclosed. The method includes receiving, by a processor, a first input from a user to pause a digital video sequence running on a display device. The digital video sequence may include a plurality of video frames and a video frame is displayed to the user when the digital video sequence is paused. The method further includes sharing, by the processor, the video frame with an image processing server to receive a processed image of the video frame. The processed image includes a plurality of objects identified in the video frame and allows navigating between the plurality of objects. The method also includes receiving, by the processor, a second input from the user. The second input may include the object of interest selected from the plurality of objects of the processed image. Furthermore, the method may include sending, by the processor, a search request to a search server, based on the selection. The search request may include information pertaining to the object of interest. The method may include providing, by the processor, search results pertaining to the object of interest received from the search server, to the user.

In accordance with another embodiment of the present subject matter, a processing device is disclosed. The processing device includes a processor, an input module coupled to the processor, and a search module coupled to the processor. The input module receives a first input from a user to pause a digital video sequence running on a display device. The digital video sequence includes a plurality of video frames and a video frame is displayed to the user when the digital video sequence is paused. The input module further shares the video frame with an image processing server to receive a processed image of the video frame. The processed image includes a plurality of objects identified in the video frame and allows navigating amongst the plurality of objects. The input module thereafter obtains a second input from the user. The second input includes the object of interest selected from the plurality of objects of the processed image. Further, the search sends a search request to a search server, module based on the selection. The search request includes information pertaining to the object of interest. The search module provides search results pertaining to the object of interest received from the search server, to the user.

In accordance with another embodiment of the present subject matter, a non-transitory computer readable medium comprising instructions to implement a method for providing information about an object in a digital video sequence is disclosed. The method includes receiving, by a processor, a first input from a user to pause a digital video sequence running on a display device. The digital video sequence may include a plurality of video frames and a video frame is displayed to the user when the digital video sequence is paused. The method further includes sharing, by the processor, the video frame with an image processing server to receive a processed image of the video frame. The processed image includes a plurality of objects identified in the video frame and allows navigating between the plurality of objects. The method also includes receiving, by the processor, a second input from the user. The second input may include the object of interest selected from the plurality of objects of the processed image. Furthermore, the method may include sending, by the processor, a search request to a search server, based on the selection. The search request may include information pertaining to the object of interest. The method may include providing, by the processor, search results pertaining to the object of interest received from the search server, to the user.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 schematically illustrates a transmission environment comprising a processing device, in accordance with an embodiment of the present subject matter.

FIG. 2 illustrate exemplary scenarios for providing information about an object in a digital video sequence, in accordance with an embodiment of the present subject matter.

FIG. 3 shows a flowchart illustrating an exemplary method for providing information about an object in a digital video sequence, in accordance with an embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

Systems and methods for providing information about an object in a digital video sequence are described. The systems and methods can be implemented in a variety of communication devices. The communication devices that can implement the described method(s) include, but are not limited to, devices such as a television (TV), smart TV, set top box and multimedia device, and the like.

In recent times, service providers have started providing information about the content being displayed to the user. For example, a user, while watching a movie on a channel, may press an “information” button of a remote of a set top box (STB) and obtain information, such as a very brief storyline and duration of the movie. In many cases, the user may like to obtain additional information about the content being displayed to the user. For example, the content being viewed by the user may be an adaptation of a novel and the user may be interested in reading the novel. However, the commercially available STB provides information which is restricted to meta-data of the content being displayed. Such meta-data provides limited information, such as the cast, a very brief storyline and the duration of the content, and may not be as detailed and informative as per the user's expectations. Thus, the user may have to independently search the information regarding the content being viewed by him which leads to reduced user experience.

Also, various content providers are now embedding information, such as coupons and unique resource locators (URLs), into videos or commercials by means of digital watermarks. The users may retrieve the embedded information by capturing the content being displayed on a display device, such as a television, with a smart phone. For example, the users may record the video sequence being displayed to the user. During recording, screen of the display device may become lighter and darker. This may be detected by a camera of the smartphone and accordingly the user may retrieve information embedded in the content. Again, as mentioned above, this provides the user with limited information and may have little or no information related to the aspect of the content in which the user may be interested in. Further, the users may need to use a smart phone to retrieve the embedded information from the displayed content.

According to an embodiment of the present subject matter, a method and a system for providing information about an object in a digital video sequence are described. The digital video sequence may be understood to include a plurality of video frames. The digital video sequence may be played on a DTV, such as a direct-to-home (DTH) television, video-on demand (VoD) device, and an Internet protocol television (IPTV). Further, the DTV may be accessed through a processing device, such as a set top box (STB) that may be integrated or provided separately to a user. The user, while watching a digital video sequence on a display device, such as a television, may pause the video sequence for different reasons. For example, the user may be interested in an object shown in the video sequence and the user would like to have a closer look at the object. To do so, the user may pause the digital video sequence by pressing a pause button. The processing device associated with the DTV may receive the pause command as a first input and the digital video sequence may get paused such that a video frame is displayed on the display device.

For allowing the user to select an object of interest from the paused video frame, the processing device may share the video frame with an image processing server for generating a processed image of the video frame. In an implementation, the processing device may convert the video frame into an image before sharing it with the image processing server. The format of the image may include, but is not limited to, Joint Photographic Expert Group (JPEG), Tagged Image File Format (TIFF), Graphics Interchange Format (GIF), and Portable Network Graphics (PNG). In another implementation, the processing device may bookmark a current play time of the video frame in a time line of the digital video sequence being displayed to the user. The bookmark may include information about a time instance at which the video frame appears in the digital video sequence. The time instance may be tagged in the time line of the digital video sequence. The bookmarked digital video sequence may then be sent to a central server by the processing device. The central server may be understood as a central server from where the digital video sequence is provided to the user by one of a DTH television, a VoD device, and an IPTV. Based on the bookmark, the central server may extract the paused video frame from the digital video sequence being displayed to the user. The central server may thereafter share the paused video frame with the image processing server. In another implementation, the processing device may share the bookmarked digital video sequence with the image processing server. The image processing server may retrieve the video frame, paused by the user, from the central server for further processing.

Once the image processing server receives the video frame, the image processing server may process the video frame to identify a plurality of objects in the processed image. The image processing server may employ any of the available object detection techniques to make the plurality of objects of the processed image identifiable. Further, the image processing server may make the plurality of objects selectable in the processed image. The image processing server may then send the processed image back to the processing device. The processed image may then be displayed to the user by the processing device. In an implementation, the user may navigate amongst the plurality of objects identified in the processed image to select the object of interest. It will be understood that the user may navigate amongst the plurality of objects by means of a controller, such as a remote control of the display device. Once the processing device receives a second input from the user, in the form of selection of the object of interest, the processing device may send a search request to a search server. The search server may be placed at a remote location. The search request may include information about the object of interest. For example, the information may include keywords related to the object of interest. The keywords may be associated by the processing device, the image processing server, the central server, and the search server, as explained below.

In an implementation, the image processing server may associate keywords with the processed image. The image processing server may tag each of the plurality of objects of the processed image with one or more keywords. Accordingly, the processed image may include keywords associated with each of the plurality of objects. When the search request is received by the search server, the search server also receives the associated keywords in the search request. The search server thereafter conducts a search for the object of interest using the associated keywords. In another implementation, the central server may associate keywords with each of the plurality of video frames of the digital video sequence. The keywords may be associated based on the content being displayed in each of the plurality of video frames. In yet another implementation, the processing device may generate keywords based on selection of the object of interest. The processing device may generate keywords based on various advertisements being displayed alongside a video frame. Typically, content related advertisements are displayed to the user by a service provider. The processing device may identify metadata from the advertisements and generate keywords. In an implementation, the search server may dynamically generate keywords related to the object of interest based on the object information. For example, the object information may include details of the object as may be obtained by the central server, metadata received from the processing device, and the like. In an implementation, the search server may maintain a list of keywords for all historical searches. Accordingly, to generate the keywords, the search server may identify the object of interest and thereafter based on the historical data, associate one or more keywords with the object of interest.

Thereafter, the search server may conduct search on the Internet for the keywords and may provide search results to the processing device for being displayed on the display device for the user. In an implementation, a filtering mechanism may be utilized by the processing device. The filtering mechanism may facilitate the processing device to filter out irrelevant results and provide the user with the relevant results. In another implementation, the search server may be configured to employ the filtering mechanism. Accordingly, the search server may display most relevant results for any search.

Accordingly, the present subject matter provides a processed image which identifies the plurality of objects in an image of a video frame. Further, present subject matter also enables a user to select an object of interest from amongst the plurality of objects. The user may also conduct search for the object of interest identified from a paused video frame of the DTV. To do so, the present subject employs a processing device for communicating with various servers to provide the user with relevant information based on the selection of the object of interest. This may save upon user's time in conducting search for the object of interest. The user may not have to open a new browser for conducting the search. The present subject matter does not require another medium, such as a smartphone, to retrieve information associated with the digital video sequence. In addition, the processing device fetches all information about the object of interest. Further, the processing device provides related information matching to the object of interest.

The above methods and system are further described in conjunction with the following figures. It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action, and the reaction that is initiated by the initial action. Additionally, the words “connected” and “coupled” are used throughout, for clarity of the description and can include either a direct connection or an indirect connection.

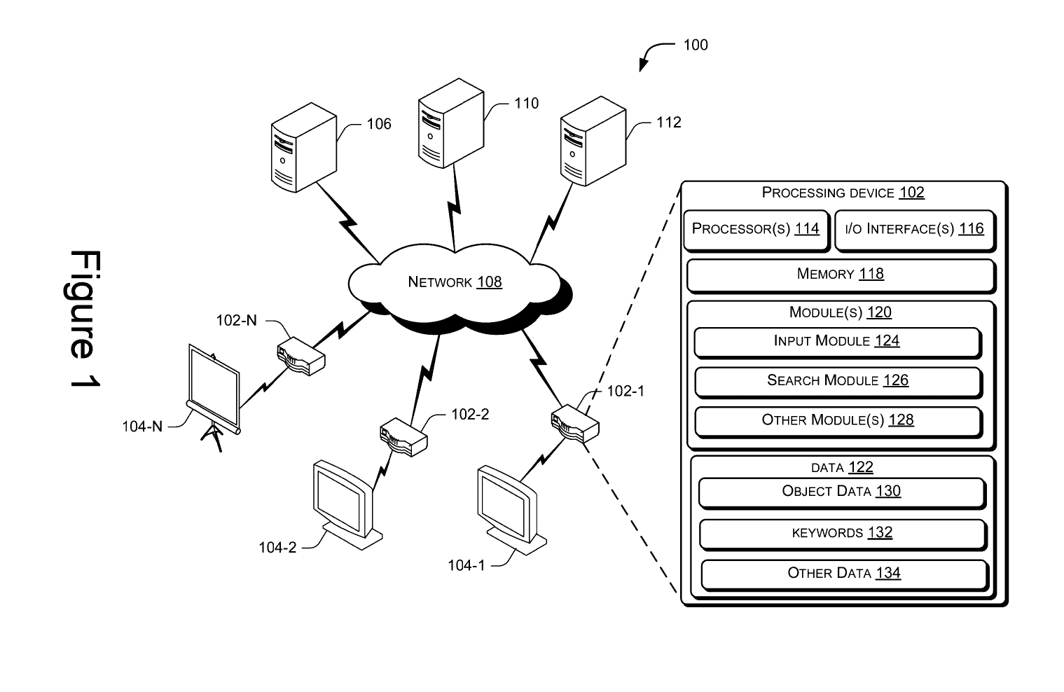

The manner in which the systems and methods for providing information about an object in a digital video sequence shall be explained in details with respect to the FIGS. 1-3. While aspects of described systems and methods for searching for an object selected in a digital video sequence can be implemented in any number of different computing systems, transmission environments, and/or configurations, the embodiments are described in the context of the following exemplary system(s).

FIG. 1 illustrates a transmission environment 100 implementing one or more processing devices 102-1, 102-2, . . . , 102-N, hereinafter collectively referred to as the processing devices 102 and individually referred to as the processing device 102. Each of the processing devices 102 are coupled to one or more display devices 104-1, 104-2, . . . , 104-N, hereinafter collectively referred to as the display devices 104 and individually referred to as the display device 104, respectively. In one implementation, the processing devices 102 may receive multimedia content from a central server 106 of a content service provider through a network 108 and subsequently provide the content to the display device 104 coupled thereto. For the purpose of explanation and clarity, one central server 106 has been shown, however, one or more central servers 106 pertaining to different service providers may exist in the transmission environment 100.

Further, the central server 106 may also be implemented on one or more discrete servers, mainframe computers, super-computers, and the like, located across different geographic locations and coupled to each other. Further, the functioning of the central server 106 may also be provided by locally installed systems, such as DSLAMs and broadband service routers, configured to provide content to the processing devices 102. The transmission environment 100 may further include an image processing server 110 and a search server 112 communicatively coupled to the processing device 102 and the central server 106 through the network 108.

The network 108 may be a combination of wired and wireless networks. The network 108 may be implemented by the service provider systems through satellite communication, terrestrial communication, or may be implemented through the use of routers and access points connected to various Digital Subscriber Line Access Multiplexers (DSLAMs) of wired networks. The network 108 can be implemented as one of the different types of networks, such as intranet, local area network (LAN), wide area network (WAN), the Internet, and such.

In one embodiment of the present subject matter, the processing devices 102, for example, a set top box, may be integrated into the display devices 104. However, in another embodiment, the processing devices 102 may be non-integral with the display devices 104. Further, the processing devices 102 can be implemented with any of a variety of display devices known in the art, such as an electro luminescent display (ELD), a plasma display panel (PDP), an organic light emitting diode (OLED), a light emitting diode (LED) display, a liquid crystal display (LCD), and a thin-film transistor LCD (TFT-LCD), and a projector coupled to a projector screen. Further, these display devices 104 may perform functions of a television set and a monitor of a computing device.

According to an embodiment of the present subject matter, a user subscribed to the services of a content service provider may view multimedia content broadcasted by the content service provider through a display device, say, the display device 104-1 coupled to the processing device 102-1. For the purpose, the processing device 102 includes one or more processor(s) 114, I/O interface(s) 116, and a memory 118 coupled to the processor(s) 114. The processor(s) 114 may be implemented as one or more microprocessors, microcomputers, microcontrollers, digital signal processors, central processing units, state machines, logic circuitries, and/or any devices that manipulate signals based on operational instructions. Among other capabilities, the processor(s) 114 are configured to fetch and execute computer-readable instructions stored in the memory 118.

The functions of the various elements shown in the figures, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The I/O interface(s) 116 may include a variety of software and hardware interfaces, for example, interfaces for peripheral device(s), such as data input output devices, referred to as I/O devices, storage devices, network devices, etc. The I/O device(s) may include Universal Serial Bus (USB) ports, Ethernet ports, host bus adaptors, etc., and their corresponding device drivers. The I/O interface(s) 116 facilitate the communication of the processing device 102 with various networks, such as the network 108 and various communication and computing devices, such as the display devices 104.

The memory 118 may include any computer-readable medium known in the art including, for example, volatile memory, such as Static Random Access Memory (SRAM) and Dynamic Random Access Memory (DRAM), and/or non-volatile memory, such as read only memory (ROM), erasable programmable ROM, flash memories, hard disks, optical disks, and magnetic tapes.

The processing device 102 may also include various modules 120 and data 122. The modules 120, amongst other things, include routines, programs, objects, components, data structures, etc., which perform particular tasks or implement particular abstract data types. The modules 120 may also be implemented as, signal processor(s), state machine(s), logic circuitries, and/or any other device or component that manipulate signals based on operational instructions.

Further, the modules 120 can be implemented in hardware, instructions executed by a processing unit, or by a combination thereof. The processing unit can comprise a computer, a processor, such as the processor 114, a state machine, a logic array or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the modules 120 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

The module(s) 120 further include an input module 124, a search module 126, and other module(s) 128. The other module(s) 128 may include programs or coded instructions that supplement applications and functions of the processing device 102. The data 122 amongst other things, serves as a repository for storing data processed, received, associated, and generated by one or more of the module(s) 128. The data 122 includes, for example, object data 130, keywords 132, and other data 134. The other data 134 includes data generated as a result of the execution of one or more modules in the other module(s) 128.

As described above, the processing device 102 facilitates a user in selecting and searching for the object of interest. The processing device 102 may allow a user to select an object of interest from a paused video frame. The processing device 102 may share the paused video frame with the image processing server 110 for generating a processed image. The processed image may allow the user to select an object of interest by navigating amongst the plurality of objects identified in the processed image of the video frame. Once the object of interest is selected by the user, the processing device 102 may send a search request to the search server 112 for conducting a search for the object of interest on the Internet. Based on the search, the processing device 102 may provide information pertaining to the object of interest to the user.

In operation, the user may pause a digital video sequence to have a closer look at a specific video frame. In an implementation, when the user pauses the digital video sequence, the input module 124 may receive a first input from the user. As may be understood, the digital video sequence is run on the display device 104 associated with the processing device 102. The user may provide the first input for pausing the digital video sequence by pressing a button on a remote control of the display device 104, by clicking on a pause icon of a media player, and the like. The input module 124 may pause the digital video sequence and as a result a video frame may be displayed to the user. The input module 124 may share the video frame with the image processing server 110 to generate a processed image of the video frame. The processed image may include a plurality of objects of the video frame and allow navigation between the plurality of objects.

In an implementation, the input module 124 may convert the video frame into an image before sharing the same with the image processing server 110. The image may be one of a Joint Photographic Experts Group (JPEG), a Tagged Image File Format (TIFF), a Graphics Interchange Format (GIF), and a Portable Network Graphics (PNG). In another implementation, the input module 124 may bookmark a current play time of the video frame in a time line of the digital video sequence being displayed to the user. The time line may be understood as a bar in which the time of the digital video sequence progresses with each video frame. The input module 124 may identify and tag an exact time instance in the digital video sequence at which the video frame appears. The input module 124 may then share the bookmark with the central server 106 of the content provider. The central server 106 may, based on the bookmark, identify and extract the video frame from the digital video sequence and share the extracted video frame with the image processing server 110 for further processing. In yet another implementation, the input module 124 may share the bookmarked digital video sequence with the image processing server 110. The image processing server 110 may communicate with the central server 106 to retrieve the video frame, as per the bookmark, for further processing.

Upon receiving the video frame, the image processing server 110 may generate a processed image from the video frame. In an implementation, the image processing server 110 may employ any of the well known image processing techniques to identify the plurality of objects in the video frame. Examples of the image processing techniques may include, but are not limited to, blob analysis, edge detection, image enhancement, image restoration, image compression, and detecting text embedded in images. In addition, the image processing server 110 may make each of the plurality of objects selectable. For example, the image processing server 110 may employ well known mechanisms to identify boundaries of each of the plurality of objects identified in the image of the video frame. The image processing server 110 may then perform pixel reduction outside boundary of each of the plurality of objects. Thereafter, the image processing server 110 may send the processed image back to the input module 124. The input module 124 may store details about each of the plurality of objects as the object data 130. The input module 124 may display the processed image of the video frame to the user, through the display device 104. The user may navigate, by means of the remote control or a navigation key, amongst the plurality of objects identified in the processed image of the video frame. To select the object of interest, a second input is provided by the user. The second input is received by the input module 124 in the form of selection of the object of interest.

In an implementation, the search module 126 may send a search request to the search server 112, based on the second input. The search request may include information about the object of interest. The information may include title of the digital video sequence, context of the video frame, information about the objects in the video frame, and the like. In an implementation, the information may be retrieved by the central server 106. Further, the search module 126 may generate a plurality of keywords for the object of interest. For example, the search module 126 may associate keywords with the video frame based on various advertisements associated with the digital video sequence. The advertisements may be shown as text alongside a video sequence. These advertisements are matched with the content of the video sequence by using various ontologies in combination with features identified from the video sequence. The search module 126 may identify metadata from the advertisements and based on the metadata generate keywords for conducting a search.

In an implementation, the image processing server 110 may generate keywords in addition to the processed image. These keywords may be associated in the form of labels with each of the plurality of objects. In another implementation, the search module 126 may send the search request to the central server 106. The central server 106 may include a repository having metadata associated with the content being displayed to the user. The central server 106 may retrieve matching keywords from the repository and share the keywords with the search server 112. Alternatively, the search server 112 may also generate keywords based on the content of the video frame. The search server 112 may maintain a search log that includes a track of various historical searches conducted and may retrieve keywords from the search log.

Thereafter, based on the keywords, the search server 112 may conduct search on the Internet for the object of interest. The search results as obtained may be shared with the search module 126. The search module 126 may store the keywords and the search results as keywords 132. The search module 126 may provide the search results to the user through the display device 104. In an implementation, the search results may be filtered before sharing with the user. The search module 126 may employ a filtering mechanism to filter the search results based on the relevance of the search results. For example, the filtering mechanism may filter the search results by identifying occurrence of the keywords in the text identified from the object of interest. Accordingly, the filtering mechanism may filter out the search results with most occurrence of the keywords. In an implementation, the search server 112 may filter the search results before sharing them with the search module 126. In yet another implementation, the central server 106 may be provided with the filtering mechanism to filter the search results. The search module 126, the central server 106, and the search server 112 may employ any of the well known filtering mechanisms or techniques to filter the search results.

Accordingly, the processing device 102 and the image processing server 110 provide a processed image that identifies the plurality of objects in an image of a video frame. The processed image enables a user to select an object of interest from amongst the plurality of objects. The user may also conduct search for the object of interest identified from a paused video frame of the DTV. To do so, the processing device 102 communicates with the central server 106, the image processing server 110, and the search server 112 to provide the user with relevant information based on the selection of the object of interest. This saves upon user's time in conducting search for the object of interest. For example, the user does not have to open a new browser for conducting the search. Further, the processing device 102 does not involve another medium, such as a smart phone, to retrieve information associated with the digital video sequence. In addition, the processing device 102 fetches all information about the object of interest and may filter the information to provide related information matching the object of interest.

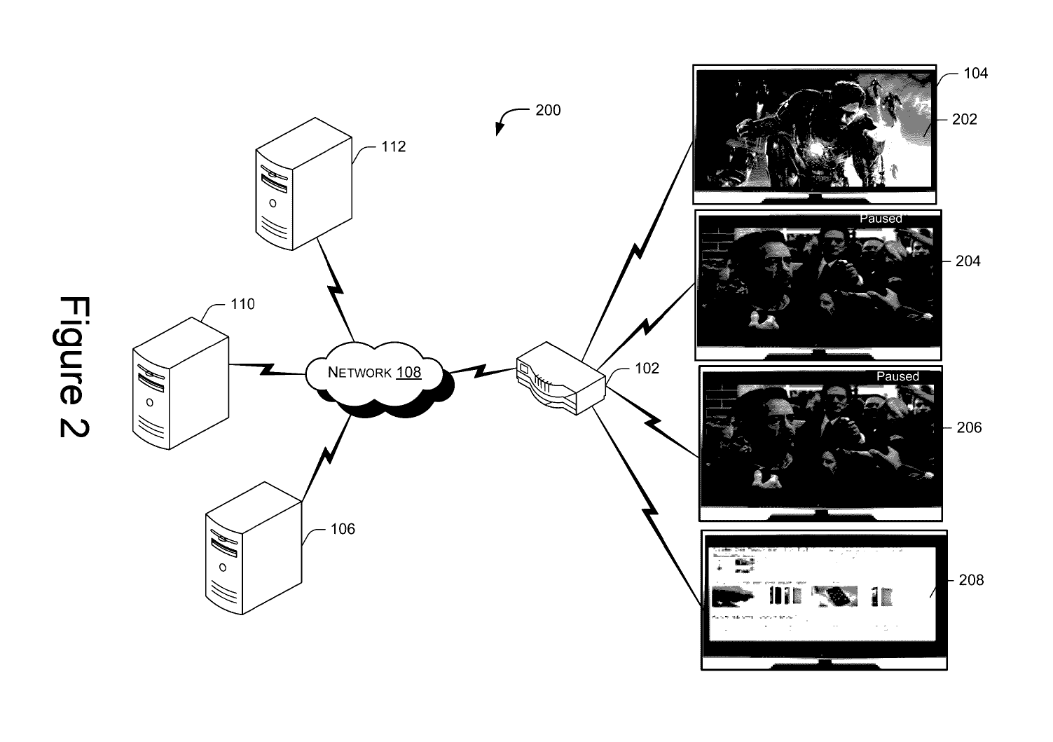

FIG. 2 illustrates exemplary scenario 200 for providing information about an object in a digital video sequence, in accordance with an embodiment of the present subject matter. FIG. 2 represents how the video frame may undergo transformation for providing information to the user. In an implementation, while the user is watching a digital video sequence, such as a movie 202, the user may wish to get more information about an object being displayed. The user may pause the movie 202, to get a video frame 204 displayed on the display device 104. The user may press a button on a remote control associated with the display device 104. As soon as the user press the button to pause the movie 202, the input module 124 of the processing device 102 may receive a first input from the user. The input module 124 may accordingly pause the movie 202, as a result of which, a video frame 204 may be displayed to the user. As mentioned above, a digital video sequence, such as the movie 202 may include a plurality of video frames.

The input module 124 may share the paused video frame 204 with the image server 110 for generating a processed image of the video frame 204. As described above, the input module 124 may bookmark the exact time instance at which the video frame 204 appears in the movie 202. The input module 124 may then share the bookmarked movie 202 with the central server 106. The central server 106 may extract the bookmarked video frame, i.e., the video frame 204 from the movie 202 and share the same with the image processing server 110. In an implementation, the input module 124 may share the bookmarked movie directly with the image processing server 110. The image processing server 110 may communicate with the central server 106 to retrieve the video frame 204 for further processing.

Further, the image processing server 110 may employ well known image processing techniques to identify the plurality of objects in the video frame 204. Examples of the image processing techniques may include, but are not limited to, blob analysis, edge detection, image enhancement, image restoration, and image compression. In addition, the image processing server 110 may make each of the plurality of objects selectable. As is shown in FIG. 2, the input module 124 displays the processed image 206 of the video frame 204 to the user, through the display device 104. The user may navigate, by means of the remote control or a navigation key, amongst the plurality of objects identified in the processed image 206 of the video frame 204. The input module 124 may receive a second input in the form of selection of the object of interest, such as a smartphone.

Based on the selection, the search module 126 of the processing device 102 may send a search request to the search server 112. The search server 112 may generate one or more keywords for the smartphone and search on the Internet. The search server 112 may then share the search results with the processing device 102. The processing device 102 may in turn display the search results 208 to the users.

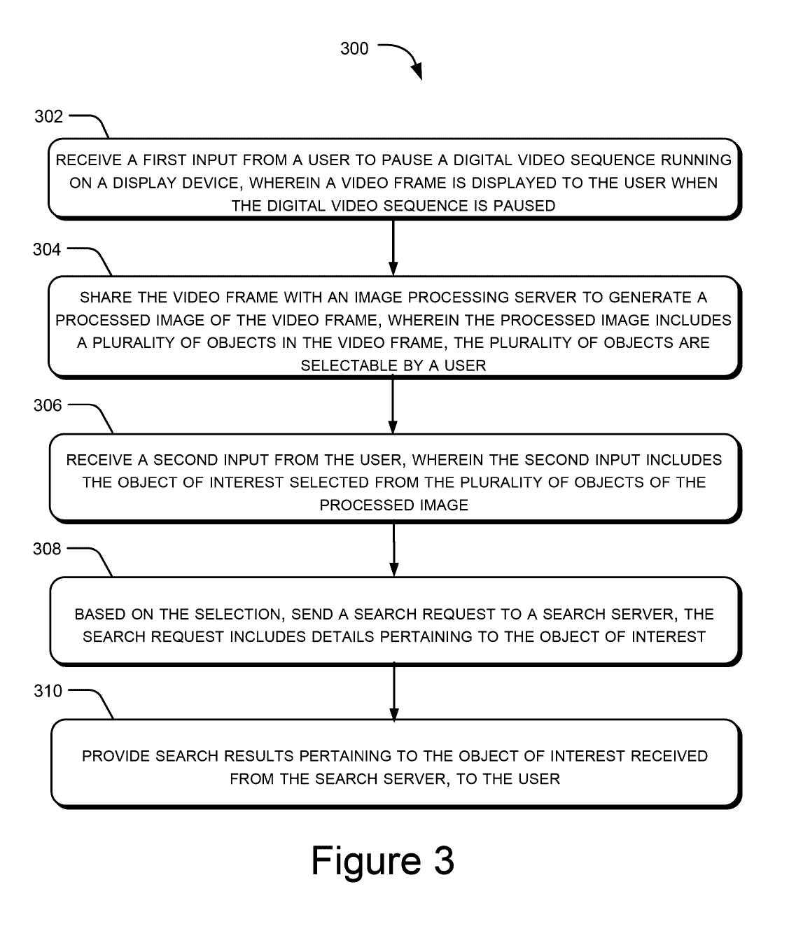

FIG. 3 illustrates a method 300 for providing information about an object in a digital video sequence, according to an embodiment of the present subject matter. The order in which the method is described is not intended to be construed as a limitation, and any number of the described method blocks can be combined in any order to implement the method 300 or any alternative method. Additionally, individual blocks may be deleted from the method without departing from the spirit and scope of the subject matter described herein. Furthermore, the method can be implemented in any suitable hardware, software, firmware, or combination thereof.

The method(s) may be described in the general context of computer executable instructions. Generally, computer executable instructions can include routines, programs, objects, components, data structures, procedures, modules, functions, etc., that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

A person skilled in the art will readily recognize that steps of the method(s) 300 can be performed by programmed computers. Herein, some embodiments are also intended to cover program storage devices or computer readable medium, for example, digital data storage media, which are machine or computer readable and encode machine-executable or computer-executable programs of instructions, where said instructions perform some or all of the steps of the described method. The program storage devices may be, for example, digital memories, magnetic storage media, such as a magnetic disks and magnetic tapes, hard drives, or optically readable digital data storage media. The embodiments are also intended to cover both communication network and communication devices to perform said steps of the method(s).

At block 302, the method 300 may include receiving a first input from a user to pause a digital video sequence 202 running on a display device 104. The digital video sequence 202 may include a plurality of video frames. Further, a video frame 204 may be displayed to the user when the digital video sequence 202 is paused. In an implementation, the input module 124 may receive the first input from the user.

At block 304, the method 300 may include sharing the paused video frame 204 with an image processing server 110 to provide a processed image 206 of the video frame 204. The processed image 206 identifies a plurality of objects of the video frame 204 and allows navigating between the plurality of objects. In an implementation, the input module 124 may display the processed image 206 to the user through the display device 104.

At block 306, the method 300 may include receiving a second input from the user. The second input includes the object of interest selected from the plurality of objects of the processed image 206. In an implementation, the input module 124 may receive the second input from the user.

At block 308, the method 300 may include sending a search request to a search server 112, based on the selection. The search request may include information pertaining to the object of interest. In an implementation, the search request is sent by the search module 126. The search server 112, upon receiving the search request may generate keywords for the object of interest and conduct a search for the object of interest as selected by the user.

At block 310, the method 300 may include providing search results pertaining to the object of interest received from the search server 112, to the user. In an implementation, the search module 126 may provide the search results to the user. Further, the search module 126 may filter the search results before providing to the user.

Although embodiments for providing information about an object in a digital video sequence have been described in a language specific to structural features or method(s), it is to be understood that the invention is not necessarily limited to the specific features or method(s) described. Rather, the specific features and methods are disclosed as embodiments for authorization of execution of a command on a remote server.

1. A method for providing information about an object in a digital video sequence, the method comprising:
receiving, by a processor, a first input from a user to pause the digital video sequence running on a display device, wherein the digital video sequence includes a plurality of video frames, and wherein a video frame is displayed to the user when the digital video sequence is paused;
sharing, by the processor, the video frame with an image processing server to receive a processed image of the video frame, wherein the processed image includes a plurality of objects identified in the video frame and allows navigating between the plurality of objects;
receiving, by the processor, a second input from the user, wherein the second input includes the object of interest selected from the plurality of objects of the processed image;
based on the selection, sending, by the processor, a search request to a search server, wherein the search request includes information pertaining to the object of interest; and
providing, by the processor, search results pertaining to the object of interest received from the search server, to the user.

2. The method as claimed in claim 1, wherein the sharing comprises converting the video frame into an image and sending the image to the image processing server.

3. The method as claimed in claim 2, wherein the image is one of Joint Photographic Experts Group (JPEG), Tagged Image File Format (TIFF), Graphics Interchange Format (GIF), and Portable Network Graphics (PNG).

4. The method as claimed in claim 1, wherein the sharing comprises,
bookmarking a current play time of the video frame in the digital video sequence; and
providing the bookmarked digital video sequence and an address of a central server, to the image processing server for retrieving the video frame from the central server for processing.

5. The method as claimed in claim 1, wherein the sharing comprises,
bookmarking a current play time of the video frame in the digital video sequence; and
sending the bookmarked digital video sequence to a central server for retrieving the video frame and forwarding the video frame to the image processing server.

6. The method as claimed in claim 1, wherein the search request includes a plurality of keywords associated with the object of interest.

7. The method as claimed in claim 1 further comprising filtering, by the processor, the search results based on relevance to the object of interest.

8. A processing device for providing information about an object in a digital video sequence, the processing system comprising:
a processor;
an input module, coupled to the processor, to,
receive a first input from a user to pause the digital video sequence running on a display device, wherein the digital video sequence includes a plurality of video frames, and wherein a video frame is displayed to the user when the digital video sequence is paused;
share the video frame with an image processing server to receive a processed image of the video frame, wherein the processed image includes a plurality of objects identified in the video frame and allows navigating amongst the plurality of objects; and
obtain a second input from the user, wherein the second input includes the object of interest selected from the plurality of objects of the processed image; and
a search module, coupled to the processor, to,
based on the selection, send a search request to a search server, wherein the search request includes information pertaining to the object of interest; and
provide search results pertaining to the object of interest received from the search server, to the user.

9. The processing device as claimed in claim 8, wherein the input module shares the video frame by converting the video frame into an image with the image processing server.

10. The processing device as claimed in claim 9, wherein the image is one of Joint Photographic Experts Group (JPEG), Tagged Image File Format (TIFF), Graphics Interchange Format (GIF), and Portable Network Graphics (PNG).

11. The processing device as claimed in claim 8, wherein the input module shares the video frame by,
bookmarking a current play time of the video frame in the digital video sequence; and
providing the bookmarked digital video sequence and an address of a central server, to the image processing server for retrieving the video frame from the central server for processing.

12. The processing device as claimed in claim 8, wherein the input module shares the video frame by,
bookmarking a current play time of the video frame in the digital video sequence; and
sending the bookmarked digital video sequence to a central server for retrieving the video frame and forwarding the video frame to the image processing server.

13. The processing device as claimed in claim 8, wherein the search request includes a plurality of keywords associated with the object of interest.

14. The processing device as claimed in claim 8, wherein the search module further filters the search results based on relevance to the object of interest.

15. A non-transitory computer-readable medium having embodied thereon a computer program for executing a method for providing information about an object in a digital video sequence, the method comprising:
receiving, by a processor, a first input from a user to pause the digital video sequence running on a display device, wherein the digital video sequence includes a plurality of video frames, and wherein a video frame is displayed to the user when the digital video sequence is paused;
sharing, by the processor, the video frame with an image processing server to receive a processed image of the video frame, wherein the processed image includes a plurality of objects identified in the video frame and allows navigating between the plurality of objects;
receiving, by the processor, a second input from the user, wherein the second input includes the object of interest selected from the plurality of objects of the processed image;
based on the selection, sending, by the processor, a search request to a search server, wherein the search request includes information pertaining to the object of interest; and
providing, by the processor, search results pertaining to the object of interest received from the search server, to the user.
